(19) United States
(12) Patent Application Publication
(10) Pub. No.: US 2023/0131851 A1
(43) Pub. Date: Apr. 27, 2023

(54) PRIORITY INDICATION IN MANEUVER COORDINATION MESSAGE

(71) Applicant: QUALCOMM Incorporated, San Diego, CA (US)

(72) Inventors: Lan YU, Beijing (CN); Dan VASSILOVSKI, Del Mar, CA (US); Hong CHENG, Basking Ridge, NJ (US); Gene Wesley MARSH, San Diego, CA (US)

(21) Appl. No.: 17/905,309

(22) PCT Filed: Apr. 9, 2020
(86) PCT No.: PCT/CN2020/084010

§ 371 Date: Aug. 30, 2022

(51) Int. Cl. G08G 1/16; H04W 4/44

(52) U.S. Cl. CPC G08G 1/166; G08G 1/163; G08G 1/164; G08G 1/167; H04W 4/44

(57) ABSTRACT

For maneuver coordination among autonomous and/ or semi-autonomous vehicles, a first vehicle can determine a maneuver and submit a maneuver request to a receiving device (e. g., a second device, road side unit, or other device). The maneuver request can include a priority designation based on the vehicle type of the first vehicle, requested maneuver type, and/or other factors. The receiving device can then determine whether to grant the maneuver request based, at least in part, on the priority included in the maneuver request.

### BACKGROUND

Vehicle-to-everything (V2X) is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly-termed road side units (RSUs)), vehicle-to-person (V2P) communication between vehicles and nearby people (pedestrians, cyclists, and other road users), and the like. Further, V2X can use any of a variety of wireless radio frequency (RF) communication technologies. Cellular V2X (CV2X), for example, is a form of V2X that uses cellular-based communication such as long-term evolution (LTE), fifth generation new radio (5G NR), and/or other cellular technologies in a direct-communication mode as defined by the 3rd Generation Partnership Project (3GPP). A component or device on a vehicle, RSU, or other V2X entity that is used to communicate V2X messages is generically referred to as a V2X device or V2X user equipment (UE).

Autonomous and semi-autonomous vehicles, including vehicles with Advanced Driver-Assistance Systems (ADAS), can communicate and coordinate maneuvers using V2X. To help V2X-capable vehicles (“V2X vehicles”) maneuver safely on the road, V2X vehicles can communicate intended maneuvers to other V2X vehicles. This can include maneuvers such as a lane change, intersection crossing, and the like, along with the corresponding time window for the behavior trajectory.

### BRIEF DESCRIPTION OF THE DRAWINGS

FIG. 1 is an illustration of an overhead view of a traffic scenario on a road.

FIG. 2 is a call flow diagram illustrating the basic functions and communication between entities when communicating intended maneuvers, according to an embodiment.

FIG. 3 is an illustration of an overhead view of another traffic scenario on a road.

FIG. 4 is a block diagram of an embodiment of a V2X device, according to an embodiment.

FIG. 5 is flow diagram of a method of vehicle maneuver coordination, according to an embodiment.

FIG. 6 is flow diagram of another method of vehicle maneuver coordination, according to an embodiment.

FIG. 7 is an illustration of a system in which vehicles may communicate over various networks and with various devices, vehicles, and servers, according to an embodiment.

FIG. 8 is a functional block diagram of a vehicle, according to an embodiment.

FIG. 9 is a perspective view of an example vehicle, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

As referred to herein, “V2X devices,” “V2X vehicles,” and “V2X entities” respectively refer to devices, vehicles, and entities capable of transmitting and receiving V2X messages. Similarly, “non-V2X vehicles” and “non-V2X entities” refer to vehicles and entities that do not or cannot engage in V2X communications. Further, a “V2X device,” which is described in more detail herein, refers to a device, system, component, or the like, which may be incorporated into and/or used by a V2X entity to enable V2X communications. Although many embodiments described “V2X vehicles” and “non-V2X vehicles,” it will be understood that many embodiments can be expanded to include non-vehicle entities, such as pedestrians, cyclists, road hazards, obstructions, and/or other traffic-related objects, etc. Further, it can be noted that embodiments may apply to vehicles and/or RSUs capable of traffic-related communication, and not necessarily to V2X-capable vehicles/RSUs. Moreover, although the embodiments provided herein can be executed by autonomous and/or semi-autonomous vehicles, embodiments are not so limited. Embodiments may, for example, include traditional (non-autonomous) vehicles having capabilities for determining and communicating intended maneuvers (e.g., within on-board navigation computer, capable of communicating instructions to a human driver). A person of ordinary skill in the art will appreciate such variations.

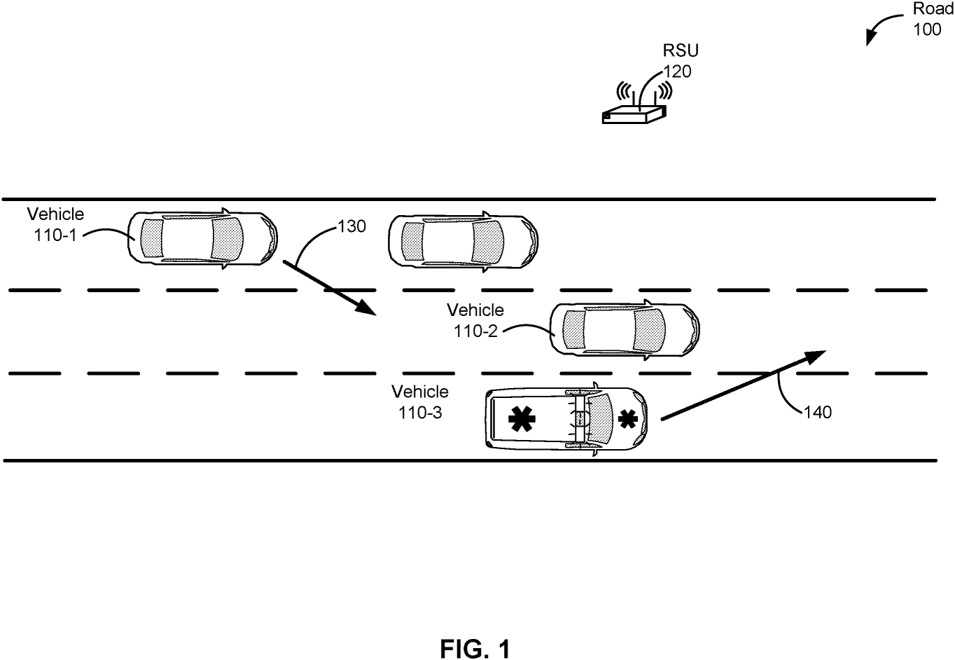

FIG. 1 is an illustration of an overhead view of a road 100, provided to help illustrate V2X vehicles can communicate intended maneuvers, according to an embodiment. Here, several vehicles, including vehicles 110-1, 110-2, 110-3, and 110-4 (collectively and generically referred to herein as vehicles 110) are driving along the road 100, and in RSU 120 is located near the road 100. (To avoid clutter, not all vehicles 110 are labeled.) It will be understood that FIG. 1, as with other figures provided herein, is provided as a non-limiting example. As a person of ordinary skill in the art will appreciate, various characteristics of the roads (number of lanes, shape, directions, intersections, etc.) can vary, as can other aspects of FIG. 1. And of course, the number, location, relative speed, and other characteristics of vehicles along the road 100 will vary as traffic conditions change.

As noted, vehicles 110 can communicate intended maneuvers with each other to help maneuver safely on the road. More specifically, vehicles 110 can communicate intended maneuvers by sending messages to one or more other vehicles 110 that may be impacted by the maneuver (e.g., by causing the other vehicles 110 to speed up or slow down, or by coming within a certain distance of the other vehicles 110). These messages include information regarding the trajectory of the maneuvers (which can include, for example, a lane change, intersection crossing, and the like) along with the corresponding time window for the behavior or trajectory. The other vehicles can respond by accepting or denying these requests.

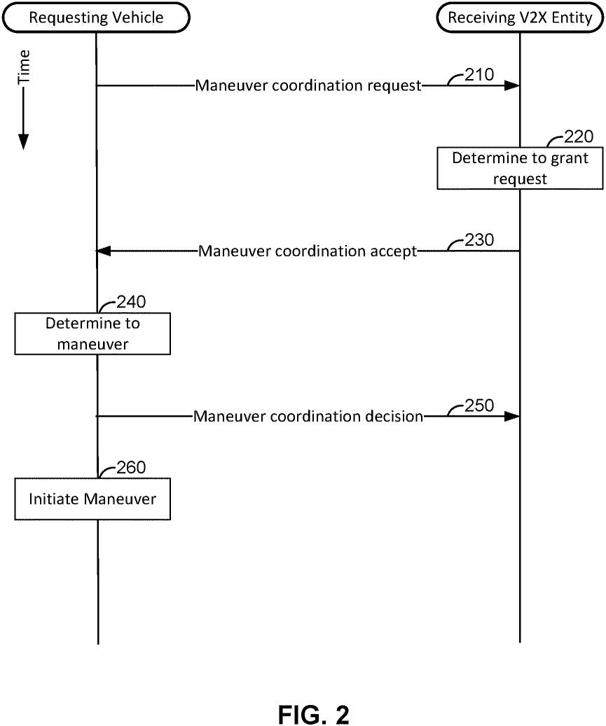

FIG. 2 is a call flow diagram illustrating the basic functions and communication between entities when communicating intended maneuvers, according to an embodiment. Here, the vehicle 110 communicating the intended maneuver is termed the “requesting vehicle.” Additionally, the entity receiving and responding to the request is termed the “receiving V2X entity.” This is because, according to some embodiments, the receiving V2X entity may not necessarily be limited to a receiving vehicle 110. For example, referring to FIG. 2, RSU 120 may coordinate vehicle movements for a designated portion of the road 100 (e.g., a predefined length of the road 100, and intersection, etc.). In such instances, therefore, the RSU 120 may receive requests from various vehicles 110 within the designated portion of the road 100. That said, the receiving V2X entity, in many instances, may comprise a vehicle that may be impacted by the intended maneuver of the requesting vehicle.

Returning again to FIG. 2, the maneuver coordination begins by the requesting vehicle sending a maneuver coordination request 210 to the receiving V2X entity. In V2X, this maneuver coordination request 210 may comprise a “Msg_Intention” message which, as previously noted, can include the planned trajectory or desired behavior of the requesting vehicle as well as a window of time in which the host vehicle intends to perform the maneuver. The planned trajectory and window of time may be determined based on the current and calculated characteristics of the vehicle, such as location, velocity, etc.

As described in more detail below, a vehicle 110 in a V2X system, such as the requesting vehicle, may determine its respective locations based on one or more of a variety of location-determination techniques. This can include, for example, Global Navigation Satellite System (GNSS) location determination, trilateration or triangulation using terrestrial transceivers (e.g., Wide Area Network (WAN)-based Observed Time Difference Of Arrival, techniques utilizing Round-Trip Time (RTT) determination, Receive Signal Strength Indication (RSSI), Angle of Arrival (AoA) and/or Angle of Departure (AoD), and the like), image-based location determination (e.g., comparing images with high definition map data), sensor-based location determination (e.g., using accelerometers, gyroscopes, magnetometers, etc.), or the like. The vehicle 110 may utilize data fusion to incorporate a plurality of location-determination techniques to determine its final location, which may be broadcast or otherwise mitigated using beacons or similar wireless techniques.

Additionally, the requesting vehicle may identify which nearby vehicles 110 may be impacted by the intended maneuver (and therefore identify one or more vehicles to which a maneuver coordination request 210 should be sent, according to some embodiments) based on current and calculated characteristics of nearby vehicles 110. These characteristics may be determined through communications from these nearby vehicles 110, sensor measurements, and information regarding the vehicles provided from an RSU 120 and/or other devices, and the like. For example, in accordance with V2X communications, nearby vehicles 110 may broadcast Basic Safety Message (BSM) or Cooperative Awareness Messages (CAM). Additionally or alternatively, the requesting vehicle may determine the absolute or relative location of nearby vehicles 110 using measurements (e.g., RTT measurements, sonar, radar, camera images, etc.).

According to embodiments, the maneuver coordination request 210 may further include a priority level to help the receiving V2X entity determine whether to grant the request (as indicated at block 220 in FIG. 2).

The maneuver coordination request 210 (another messaging described herein) may be sent and received via various means, protocols and standards, and may include message elements standardized by V2X-related groups, such as Society of Automotive Engineers (SAE) or European Telecommunications Standards Institute (ETSI). Accordingly, the message elements used in the maneuver coordination request 210 (e.g., used to convey the intended maneuver, the window of time, and the priority, for example) may comprise application-layer information elements.

The requesting vehicle may determine the priority of the maneuver coordination request 210 based on factors such as the requesting vehicle’s type and the reasoning for the requested maneuver. These priority levels may be based on common rules and factors standardized in the application layer. Table 1 provides an example of a priority definition for a lane change maneuver coordination request. Priority levels for other types of maneuvers may be similarly determined.

TABLE 1

Example Lane Change Priority Levels
Vehicle Type

| Reason for Lane Change | Emergency Vehicle | Ordinary Vehicle |
|---|---|---|
| Strategy | Priority 0 | Priority 3 |
| Cooperative | Priority 1 | Priority 4 |
| Tactic | Priority 2 | Priority 5 |

Here, the factors considered include a reason for the maneuver, as well as vehicle type. As can be seen, the reason for the requested lane change falls into one of three categories: Strategy (e.g., to continue a route), Cooperative (e.g., to make room for other vehicles), or Tactic (e.g., for speed gain). Moreover, the vehicle type falls into one of two categories: emergency vehicle or ordinary vehicle. That said, alternative embodiments may include additional or alternative prioritization factors (e.g., based on an emergency vehicle type, maneuvering or other capabilities of the requesting vehicle, etc.). Alternative embodiments may also have additional or alternative vehicle types or reasons for lane change (including, for example, accident avoidance, which may be given a relatively high priority). In Table 1, maneuvers having PRIORITY 0 are given the highest priority, while those having priority 5 are given the lowest priority.

The receiving V2X entity can then determine to grant the request 220 based on, for example, the requested maneuver type, priority level, maneuver requests from other requesting vehicles, (in cases where the receiving V2X entity comprises a receiving vehicle) its own motion state, road conditions, traffic environment, and/or other such factors. Different factors may be given different weight, and the receiving V2X entity can balance each of the factors to make the determination. The fact that the maneuver coordination request 210 can include a priority level allows the receiving V2X entity to make more intelligent decisions on whether to grant requests.

For example, a receiving V2X entity comprising a receiving vehicle may disregard any lane change request from the requesting vehicle if granting the request would result in the receiving vehicle responding by altering its operation in a manner that would put its passenger in any danger. However, in some embodiments, the receiving vehicle may grant such a lane change request if the priority is above a certain threshold (e.g., priority 0 or 1 in Table 1), and the danger to passengers in the receiving vehicle is relatively low.

If the receiving V2X entity decides to grant the request, it may send a maneuver coordination accept 230. According to V2X communication, this maneuver coordination accept 230 may comprise a “Msg _Response” message which, indicates the receiving V2X entity’s acceptance of the requested maneuver. (Alternatively, if the receiving V2X entity denies the request, it may send the denial in a similar manner.)

Upon receiving an acceptance, the requesting vehicle may then determine to perform the maneuver 240. (It can be noted, however, that the requesting vehicle may have sent a similar maneuver coordination request to one or more other receiving V2X entities, and may therefore wait until receiving acceptances from all of the receiving V2X entities before deciding to decide to make the maneuver. However, once it decides to make the maneuver, the requesting vehicle may then send the maneuver coordination decision 250 to the receiving V2X entity, as illustrated in FIG. 2, notifying the receiving V2X entity that the requesting vehicle will execute the maneuver. The requesting vehicle can then initiate the maneuver 260.

Returning to FIG. 1, for example, a first vehicle 110-1 may want to travel along a route 130, changing lanes to increase speed. Given the location and speed of a second vehicle 110-2 (as determined by the first vehicle 110-1), the first vehicle 110-1 can send the second vehicle 110-2 a maneuver coordination request 210, indicating the route 130, a window of time in which to make the maneuver, and a priority level of the maneuver. Because the maneuver is Tactic (for speed gain), and because the first vehicle 110-1 is considered an ordinary (non-emergency) vehicle, the priority of the maneuver is priority 5, according to Table 1. Despite having a relatively low priority, the second vehicle 110-2 may grant the request depending on the previously-described factors.

However, if the second vehicle 110-2 receives another, higher-priority request, it may deny the maneuver request from the first vehicle 110-1 if the second vehicle 110-2 is incapable of granting both requests. For example, if a third vehicle 110-3 comprising an emergency vehicle sends a maneuver coordination request 210 to the second vehicle 110-2, this may cause the second vehicle 110-2 to deny the first vehicle 110-1 its request, while granting the maneuver request from the third vehicle 110-3. More specifically, if the maneuver request from the third vehicle 110-3 indicates Tactic maneuver (for speed gain) along Route 140, the maneuver request may correspondingly include a priority of 2 (again, based on Table 1). After it receives the maneuver request from the third vehicle 110-3, the second vehicle 110-2 may determine that it would be unable to grant the requests of both the third vehicle 110-3 and the first vehicle 110-1 based on an overlapping window of time for each vehicle to perform its respective maneuver and/or a conflicting resulting response from vehicle 110-2 (e.g., granting the request from the third vehicle 110-3 may require the second vehicle 110-2 to slow down, whereas granting the request from the first vehicle 110-1 may require the second vehicle 110-2 to speed up). Because it is unable to grant both requests, the second vehicle 110-2 may therefore grant the request of the third vehicle 110-3 and deny the request of the first vehicle 110-1, based on the fact that the request from the third vehicle 110-3 had a higher priority than that of the first vehicle 110-1. In accordance with the method illustrated in FIG. 2, therefore, the second vehicle 110-2 may send a maneuver coordination accept 230 message to the third vehicle 110-3 and send a denial message to the first vehicle 110-1. And after receiving a maneuver coordination decision 250 from the third vehicle 110-3 indicating that the third vehicle 110-3 will initiate the maneuver, the second vehicle 110-2 can then slow down to allow the third vehicle 110-3 to perform the maneuver.

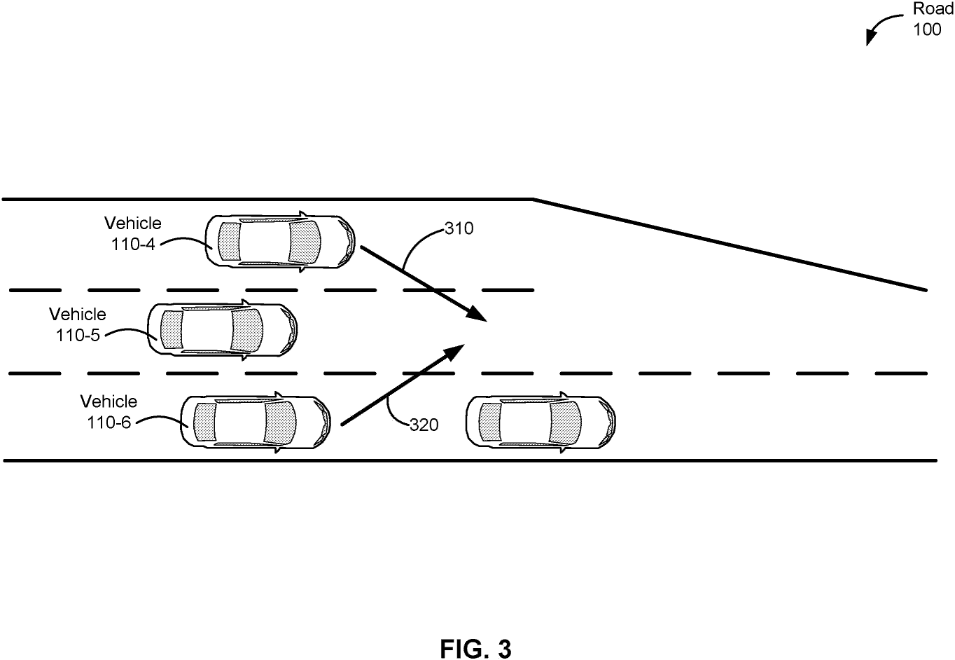

FIG. 3 is an illustration of an overhead view of a road 100, providing yet another example of how prioritization of maneuver request messages can be used by a vehicle 110 to determine whether to grant and/or deny the maneuver request messages. Here, a fourth vehicle 110-4 sends a maneuver request to a fifth vehicle 110-5, indicating an intended maneuver along a route 310, within a respective time window, and having a corresponding priority. In this case, the reason for the fourth vehicle 110-4 to change lanes is for Strategy (to continue its route). Because of this, and because the fourth vehicle 110-4 is an ordinary vehicle, the maneuver request can include a priority level of 3, in accordance with the priority levels shown in Table 1.

Additionally, however, a sixth vehicle 110-6 sends a maneuver request to the fifth vehicle 110-5, indicating an intended maneuver along a route 320, within a respective time window that may overlap with (or be within a threshold time difference of) the time window of the intended maneuver of the fourth vehicle 110-4. Here, though, the reason for the sixth vehicle 110-6 to change lanes is Tactic (for speed gain). Because the sixth vehicle 110-6 is also an ordinary vehicle, the corresponding maneuver request can have a priority level of 5, in accordance with the priority levels shown in Table 1.

Similar to the scenario in FIG. 1, the requests conflict. That is, the fourth vehicle 110-4 and the sixth vehicle 110-6 cannot execute their respective intended maneuvers because it would result in a potential crash between the vehicles-- both moving into substantially the same location on the road 100 at substantially the same time. Unlike the scenario in FIG. 1, however, the requirement of the fifth vehicle 110-5 for granting either request is the same: it simply needs to decelerate. However, even though the fifth vehicle 110-5 can take the same action (slowing down) to grant both requests, the fifth vehicle 110-5 can still determine that granting maneuver requests from both of the fourth vehicle 110-4 and the sixth of vehicle 110-6 would be conflicting. As such, the fifth vehicle 110-5 can determine to grant one request and deny the other. And because the priority of the request of the fourth vehicle 110-4 is higher than that of the sixth vehicle 110-6, the fifth vehicle 110-5 can then grant the request of the fourth vehicle 110-4 and deny the request of the sixth vehicle 110-6.

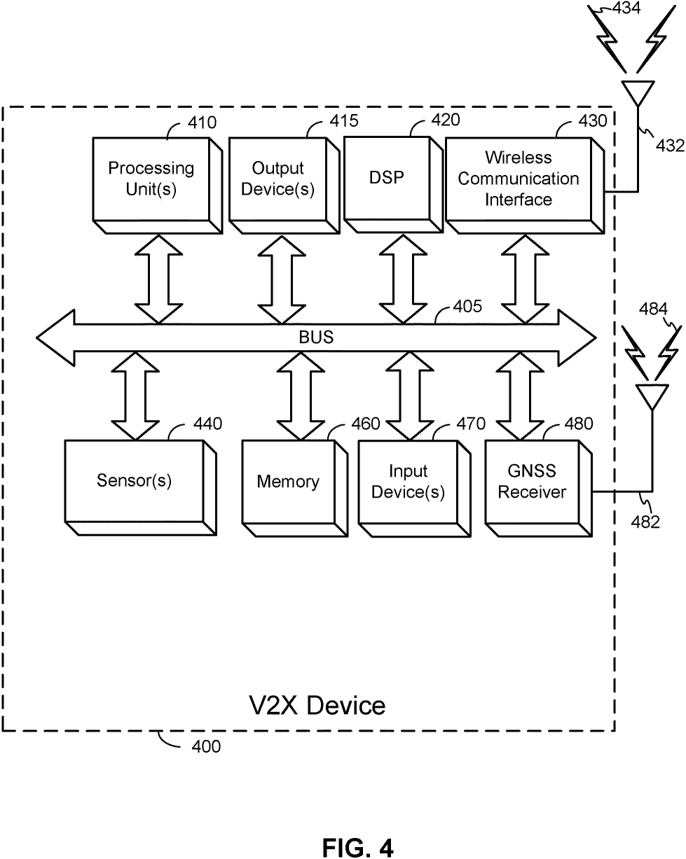

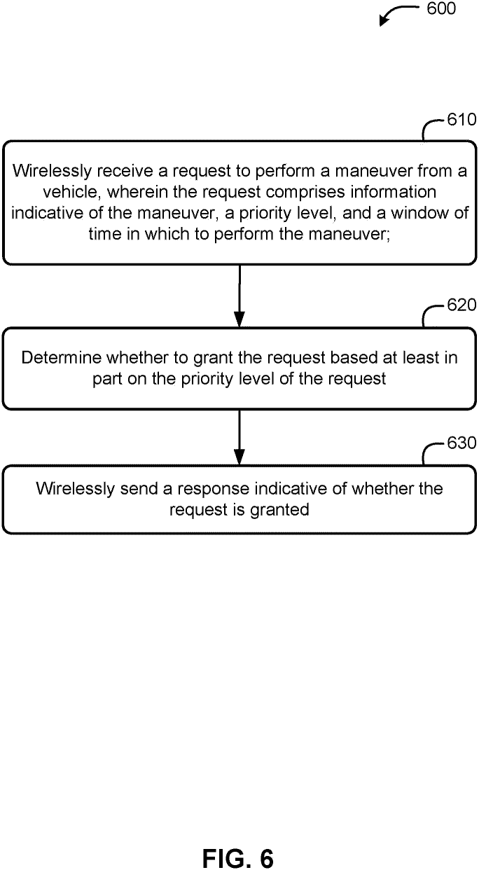

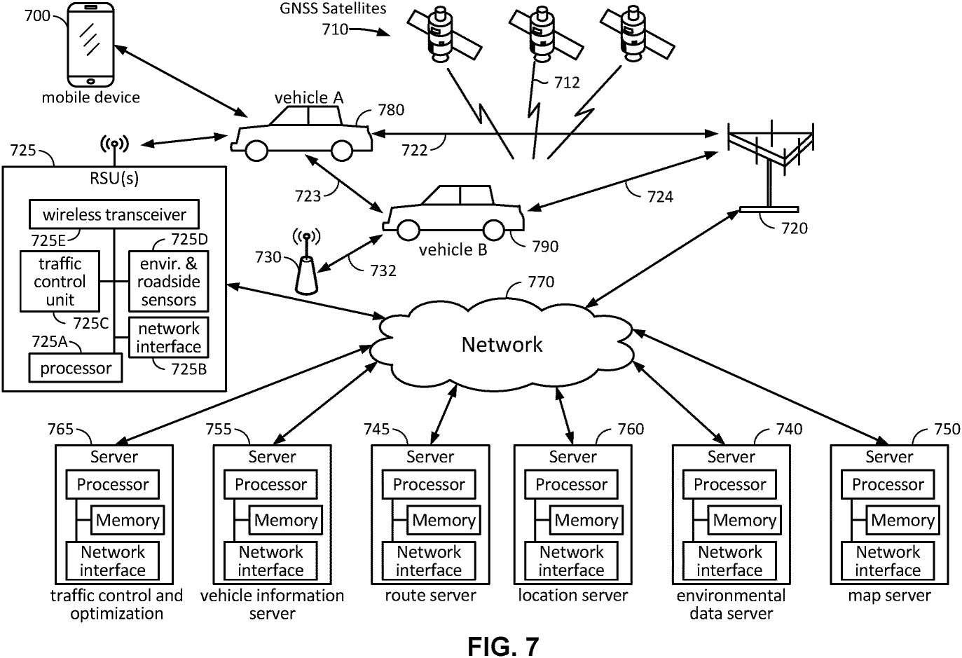

FIG. 4 is a block diagram of an embodiment of a V2X device 400, which may be utilized by and/or integrated into a vehicle 110, RSU 120, or any other system or device to wirelessly communicate with vehicles 110 and/or RSUs as previously described. When utilized by a vehicle 110, the V2X device 400 may comprise or be integrated into a vehicle computer system used to manage one or more systems related to the vehicle’s navigation and/or automated driving, as well as communicate with other onboard systems and/or other traffic entities. When utilized by an RSU 120, the V2X device 400 may cause the RSU 120 to perform the functionality of the receiving V2X entity as described with regard to FIG. 2, and/or one or more of the functions of method 600 shown in FIG. 6, which is later described. Moreover, the V2X device 400 may be integrated into an RSU computer system, which may include additional components and may perform additional RSU-related functionality. Such RSU-related functionality and additional components of an RSU are described in more detail below with regard to FIG. 7. With this in mind, according to some embodiments, the V2X device 400 may comprise a stand-alone device or component of a vehicle 110 or RSU 120, which may be communicatively coupled with other components/devices of the vehicle 110 or RSU 120. It also can be noted that the V2X device 400 may be utilized in the similar manner by V2X entities other than a vehicle 110 or RSU 120. Additionally, embodiments may not necessarily be limited to V2X communications. As such, alternative embodiments may include a device similar to the V2X device 400, having similar components to those shown in FIG. 4 and capable of performing the functions of the vehicles 110 and/or RSU 120 described in the previously-discussed embodiments, but without V2X functionality.

It should also be noted that FIG. 4 is meant only to provide a generalized illustration of various components, any or all of which may be utilized as appropriate. It can be noted that, in some instances, components illustrated by FIG. 4 can be localized to a single physical device and/or distributed among various networked devices, which may be located, for example, at different physical locations on a vehicle 110, RSU 120, or other V2X entity.

The V2X device 400 is shown comprising hardware elements that can be electrically coupled via a bus 405 (or may otherwise be in communication, as appropriate). The hardware elements may include a processing unit(s) 410 which can include without limitation one or more general-purpose processors, one or more special-purpose processors (such as digital signal processing (DSP) chips, graphics acceleration processors, application-specific integrated circuits (ASICs), and/or the like), and/or other processing structure or means.

The V2X device 400 also can include one or more input devices 470, which can include devices related to user interface (e.g., a touch screen, touchpad, microphone, button(s), dial(s), switch(es), and/or the like) and/or devices related to navigation, automated driving, and the like. Similarly, the one or more output devices 415 may be related to interacting with a user (e.g., via a display, light emitting diode(s) (LED(s)), speaker(s), etc.), and/or devices related to navigation, automated driving, and the like.

The V2X device 400 may also include a wireless communication interface 430, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device and/or various cellular devices, etc.), and/or the like. (Examples of such communication are provided in FIG. 7 and described in more detail below.) The wireless communication interface 430 can enable the V2X device 400 to communicate to other V2X devices. This can include the various forms of communication of the previously-described embodiments, including the messaging illustrated in FIG. 2. And as such, it may be capable of transmitting direct communications, broadcasting wireless signals, receiving direct and/or broadcast wireless signals, and so forth. Accordingly, the wireless communication interface 430 may be capable of sending and/or receiving RF signals from various RF channels/frequency bands. Communication using the wireless communication interface 430 can be carried out via one or more wireless communication antenna(s) 432 that send and/or receive wireless signals 434.

The V2X device 400 can further include sensor(s) 440. Sensors 440 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like). Sensors 440 may be used, for example, to determine certain real-time characteristics of the vehicle, such as location, velocity, acceleration, and the like. As previously indicated, sensor(s) 440 may be used to help a vehicle 110 determine its location.

Embodiments of the V2X device 400 may also include a GNSS receiver 480 capable of receiving signals 484 from one or more GNSS satellites using an antenna 482 (which, in some embodiments, may be the same as antenna 432). Positioning based on GNSS signal measurement can be utilized to determine a current location of the V2X device 400, and may further be used as a basis to determine the location of a detected object. The GNSS receiver 480 can extract a position of the V2X device 400, using conventional techniques, from GNSS satellites of a GNSS system, such as Global Positioning System (GPS) and/or similar satellite systems.

The V2X device 400 may further comprise and/or be in communication with a memory 460. The memory 460 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

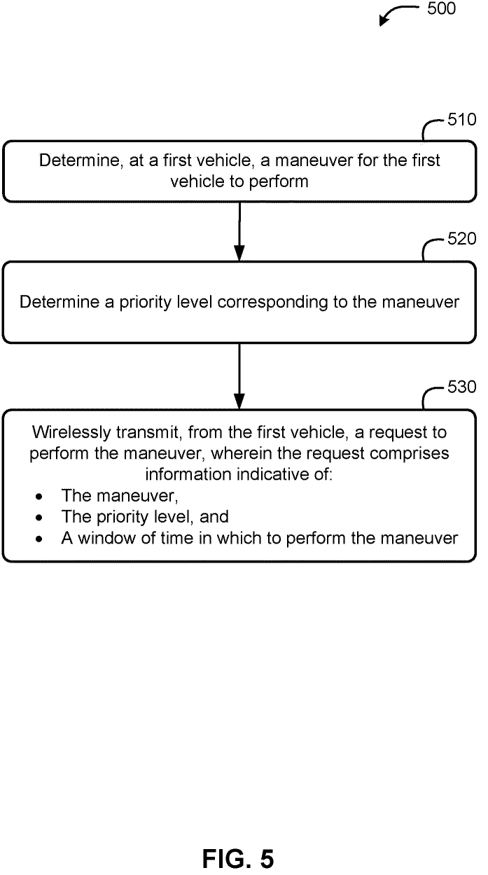

The memory 460 of the V2X device 400 also can comprise software elements (not shown in FIG. 4), including an operating system, device drivers, executable libraries, and/or other code, such as one or more application programs, which may comprise computer programs provided by various embodiments, and/or may be designed to implement methods and/or configure systems as described herein. Software applications stored in memory 460 and executed by processing unit(s) 410 may be used to implement the functionality of a vehicle 110 or RSU 120 as described herein. Moreover, one or more procedures described with respect to the method(s) discussed herein may be implemented as code and/or instructions in memory 460 that are executable by the V2X device 400 (and/or processing unit(s) 410 or DSP 420 within V2X device 400), including the functions illustrated in the methods of FIGS. 5 and 6 described below. In an aspect, then, such code and/or instructions can be used to configure and/or adapt a general-purpose computer (or other device) to perform one or more operations in accordance with the described methods.

FIG. 5 is a flow diagram of a method 500 of vehicle maneuver coordination, according to an embodiment. Alternative embodiments may vary in function by combining, separating, or otherwise varying the functionality described in the blocks illustrated in FIG. 5. The method 500 of FIG. 5 illustrates how the functionality of a requesting vehicle described above (e.g., with regard to FIG. 2) may be implemented, according to an embodiment. As such, the means for performing the functionality of one or more of the blocks illustrated in FIG. 5 may comprise hardware and/or software components of a vehicle 110, which (as previously noted) may include one or more components of the V2X device 400 illustrated in FIG. 4 and described above.

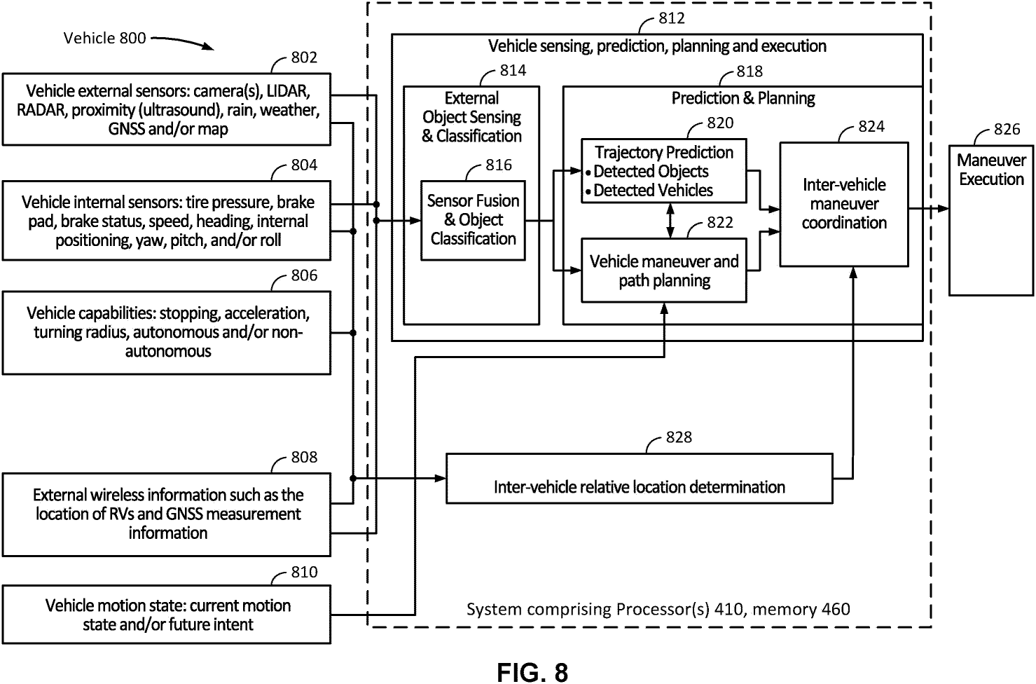

At block 510, the functionality comprises determining, at a first vehicle, a maneuver for the first vehicle to perform. As previously noted, this determination may be made by an on-board computer of the first vehicle (e.g., executing vehicle navigation, autonomous, and/or semi-autonomous driving, etc.). In some embodiments, therefore, the determination may be made by a V2X device 400, which may execute vehicle sensing, prediction, planning, and execution (as noted in FIG. 8 and described in more detail below). The maneuver may include any of a variety of maneuvers that may impact nearby vehicles, such as changing lanes, accelerating/decelerating, maneuvering through an intersection, etc. Means for performing the functionality at block 510 may include one or more software and/or hardware components of a V2X device, such as a bus 405, processing unit(s) 410, memory 460, and/or other software and/or hardware components of the V2X device 400 illustrated in FIG. 4.

The functionality at block 520 comprises determining a priority level corresponding to the maneuver. As indicated in the embodiments described previously, priority levels may be predetermined based on various factors, such as a vehicle type (e.g., emergency or ordinary), reason for the maneuver, or both. In some embodiments, priorities may be predetermined based on maneuver type (e.g., some maneuvers may be given higher priorities than others), although, as noted, embodiments may additionally or alternatively provide similar functionality by allowing the maneuver type to be considered by the receiving vehicle when determining whether or not to grant the maneuver request. Means for performing the functionality at block 520 may include one or more software and/or hardware components of a V2X device, such as a bus 405, processing unit(s) 410, memory 460, and/or other software and/or hardware components of the V2X device 400 illustrated in FIG. 4.

At block 530 the functionality comprises wirelessly transmitting, from the first vehicle, a request to perform the maneuver. The request comprises information indicative of the maneuver, the priority level, and a window of time in which to perform the maneuver. As previously noted, the window of time in which to perform the maneuver may be determined by the first vehicle (e.g., by processing unit(s) 410 of a V2X device 400 integrated into the first vehicle), based on characteristics such as vehicle speed, maneuvering capabilities, location, and so forth. According to some embodiments, the first message may be wirelessly transmitted in accordance with the V2X communication standard, or other wireless communication standards enabling communications between vehicles, infrastructure, and/or other traffic-related entities. Means for performing the functionality at block 530 may include one or more software and/or hardware components of a V2X device, such as a bus 405, processing unit(s) 410, memory 460, wireless communication interface 430, and/or other software and/or hardware components of the V2X device 400 illustrated in FIG. 4.

As indicated in FIG. 2, the request may be granted or denied, and the requesting vehicle can respond accordingly. Thus, embodiments of the method 500 may further comprise receiving, at the first vehicle, an acceptance message from the second vehicle, and, responsive to receiving the acceptance message from a second vehicle, performing the maneuver with the first vehicle.

FIG. 6 is a flow diagram of a method 600 of vehicle maneuver coordination, according to an embodiment. Alternative embodiments may vary in function by combining, separating, or otherwise varying the functionality described in the blocks illustrated in FIG. 6. The method 600 of FIG. 6 illustrates how the functionality of a receiving V2X entity (e.g., receiving vehicle or RSU) described above (e.g., with regard to FIG. 2) may be implemented, according to an embodiment. As such, the means for performing the functionality of one or more of the blocks illustrated in FIG. 6 may comprise hardware and/or software components of the V2X device 400 illustrated in FIG. 4 and described above.

At block 610, the functionality comprises wirelessly receiving a request to perform a maneuver from a vehicle, wherein the request comprises information indicative of the maneuver, a priority level, and a window of time in which to perform the maneuver. This request may be wirelessly received via V2X communication and/or other wireless means. Means for performing the functionality at block 610 may include one or more software and/or hardware components of a V2X device, such as a bus 405, processing unit(s) 410, memory 460, wireless communication interface 430, and/or other software and/or hardware components of the V2X device 400 illustrated in FIG. 4.

The functionality at block 620 comprises determining whether to grant the request based at least in part on the priority level of the request. As noted in the embodiments above, the priority level can be used to determine which among multiple requests to grant. Additionally or alternatively, the priority level can be used, along with other factors such as road conditions, traffic environment, a receiving vehicle’s motion state, and the like. Means for performing the functionality at block 620 may include one or more software and/or hardware components of a V2X device, such as a bus 405, processing unit(s) 410, memory 460, and/or other software and/or hardware components of the V2X device 400 illustrated in FIG. 4.

At block 630 the functionality comprises wirelessly sending a response indicative of whether the request is granted. A grant of the request may enable the requesting vehicle to perform the maneuver, while a denial may result in the requesting vehicle not performing the maneuver. Additionally, as indicated in the above-described embodiments, the receiving V2X entity may grant some requests while denying others if requests are conflicting (e.g., if granting request would result in danger to one or more vehicles). Means for performing the functionality at block 630 may include one or more software and/or hardware components of a V2X device, such as a bus 405, processing unit(s) 410, memory 460, wireless communication interface 430, and/or other software and/or hardware components of the V2X device 400 illustrated in FIG. 4.

In some instances, in which the, requesting vehicle comprises a first vehicle the method 600 may be performed by a receiving vehicle comprising a second vehicle. In such instances, receiving the request, determining whether to grant the request, and wirelessly sending the response may all be performed by the second vehicle. Moreover, in some instances (e.g., as described in the embodiments of FIGS. 1 and 3), the second vehicle may receive one or more requests from different vehicles, such as a first request from the first vehicle and a second request from a third vehicle. The second vehicle may determine to grant the first request additionally based on a priority level of the second request received by the second vehicle from the third vehicle. In such instances, determining whether to grant the first request may comprise determining to deny the first request based on a determination that the priority level of the second request is higher than the priority level of the first request, and the response therefore comprises information indicative of a denial of the first request. Alternatively, determining whether to grant the first request may comprise determining to accept the first request based on a determination that the priority level of the second request is lower than the priority level of the first request, in which case the response may comprise information indicative of an acceptance of the first request.

FIGS. 7-9 are illustrations of systems, structural devices, vehicle components, and other devices, components, and systems related to V2X communications, which can be used to implement the techniques provided herein for coordination of vehicle maneuvers among a plurality of vehicles, according to some embodiments. It can be noted that some components in these figures (e.g., RSU(s) 725 and vehicles 780, 790, 800, 900) may correspond to like components in the previously-described embodiments and figures (e.g., RSU 120 and vehicles 110).

FIG. 7 is an illustration of a system in which vehicles may communicate over various networks and with various devices, vehicles, and servers, according to an embodiment. In an embodiment, V2X vehicle A 780 may communicate with V2X or otherwise communication-transceiver-enabled vehicle B 790, using V2X or other wireless communication transceiver over link 723. Some embodiments may, for example communicate to perform inter-vehicle relative positioning, negotiation for lane changes, for passage through an intersection, and/or to exchange V2X data elements such as GNSS measurements, vehicle status, vehicle location and vehicle abilities, measurement data, and/or calculated status. Such communications may additionally or alternatively be used to exchange other V2X vehicle status steps that may not be covered in the V2X capability data elements.

In some embodiments, vehicle A 780 may also communicate with vehicle B 790 through a network. This can be done using wireless signals 722/724 to/from base station 720 and/or via wireless signals 732 to/from an access point 730. Additionally or alternatively, such communication can be done via one or more communication-enabled RSU(s) 725, any of which may relay communication, information, and/or convert protocols for use by other vehicles, such as vehicle B 790. This latter functionality can be done, for example, in an embodiment where vehicle B 790 is not capable of communicating directly with vehicle A 780 in a common protocol. In an embodiment, RSU(s) 725 may comprise various types of roadside beacons, traffic and/or vehicular monitors, traffic control devices, and location beacons. Moreover, as noted earlier, RSU(s) 725 may correspond to RSU 120 illustrated in FIGS. 1 and 3, and therefore may include components of a V2X device 400 as illustrated in FIG. 4 (which may be used in addition or as an alternative to the components of the RSU(s) 725 illustrated in FIG. 7, which are described below), and which may be configured to perform the method 600 of vehicle maneuver coordination FIG. 6.

In an embodiment, RSU(s) 725 may have a processor 725A configured to operate wireless transceiver 725E to send and receive wireless messages, for example, a BSM, CAM, or other V2X messages to/from vehicle A 780 and/or vehicle B 790, from base station 720 and/or access point 730. For example, wireless transceiver 725E may send and/or receive wireless messages in various protocols such as V2X communication with vehicles (e.g., using sidelink communication), and/or using various Wide Area Network (WAN), Wireless Local Area Network (WLAN), and/or Personal Area Network (PAN) protocols to communicate over a wireless communication network. In an embodiment RSU(s) 725 may contain one or more processors 725A communicatively coupled to wireless transceiver 725E and memory, and may contain instructions and/or hardware to perform as a traffic control unit 725C and/or to provide and/or process environmental and roadside sensor information 725D or to act as a location reference for GNSS relative location between it and vehicles. In an embodiment, RSU(s) 725 may contain a network interface 725B (and/or a wireless transceiver 725E), which, in an embodiment, may communicate with external servers such as traffic optimization server 765, vehicle information server 755, and/or environmental data server 740. In an embodiment, wireless transceiver 725E may communicate over a wireless communication network by transmitting or receiving wireless signals from a wireless Base Transceiver Subsystem (BTS), a Node B or an evolved NodeB (eNodeB) or a next generation NodeB (gNodeB) over wireless communication link. In an embodiment, wireless transceiver(s) 725E may comprise various combinations of WAN, WLAN and/or PAN transceivers. In an embodiment, a local transceiver may also be a Bluetooth® transceiver, a ZigBee transceiver, or other PAN transceiver. A local transceiver, a WAN wireless transceiver and/or a mobile wireless transceiver may comprise a WAN transceiver, an access point (AP), femtocell, Home Base Station, small cell base station, Home Node B (HNB), Home eNodeB (HeNB) or next generation NodeB (gNodeB) and may provide access to a wireless local area network (WLAN, e.g., IEEE 902.11 network), a wireless personal area network (PAN, e.g., Bluetooth network) or a cellular network (e.g. an LTE network or other wireless wide area network such as those discussed in the next paragraph). It should be understood that these are merely examples of networks that may communicate with an RSU(s) 725 over a wireless link, and claimed subject matter is not limited in this respect.

RSU(s) 725 may receive location, status, GNSS and other sensor measurements, and capability information from vehicle A 780 and/or vehicle B 790 such as GNSS measurements, sensor measurements, velocity, heading, location, stopping distance, priority or emergency status and other vehicle-related information. In an embodiment, environmental information such as road surface information/status, weather status, and camera information may be gathered and shared with vehicles, either via point to point or broadcast messaging. RSU(s) 725 may utilize received information, via wireless transceiver 725E, from vehicle A 780 and/or vehicle B 790, environmental and roadside sensors 725D, and network information and control messages from, for example, traffic control and optimization server 765 to coordinate and direct traffic flow and to provide environmental, vehicular, safety and announcement messages to vehicle A 780 and vehicle B 790.

Processor 725A may be configured to operate a network interface 725B, in an embodiment, which may be connected via a backhaul to network 770, and which may be used, in an embodiment, to communicate and coordinate with various centralized servers such as a centralized traffic control and optimization server 765 that monitors and optimizes the flow of traffic in an area such as within a city or a section of a city or in a region. Network interface 725B may also be utilized for remote access to RSU(s) 725 for crowd sourcing of vehicle data, maintenance of the RSU(s) 725, and/or coordination with other RSU(s) 725 or other uses. RSU(s) 725 may have a processor 725A configured to operate traffic control unit 725C which may be configured to process data received from vehicles such as vehicle A 780 and vehicle B 790 such as location data, stopping distance data, road condition data, identification data and other information related to the status and location of nearby vehicles and environment. RSU(s) 725 may have a processor 725A configured to obtain data from environmental and roadside sensors 725D, which may include temperature, weather, camera, pressure sensors, road sensors (for car detection, for example), accident detection, movement detection, speed detection and other vehicle and environmental monitoring sensors.

In an embodiment, vehicle A 780 may also communicate with mobile device 700 using short range communication and personal networks such as Bluetooth, Wi-Fi or Zigbee or via V2X (e.g., CV2X/sidelink communications) or other vehicle-related communication protocols, for example, in an embodiment to access WAN and/or Wi-Fi networks and/or, in an embodiment, to obtain sensor and/or location measurements from mobile device 700. In an embodiment, vehicle A 780 may communicate with mobile device 700 using WAN related protocols through a WAN network, such as via WAN base station 720 or using Wi-Fi either directly peer to peer or via a Wi-Fi access point. Vehicle A 780 and/or vehicle B 790 may communicate using various communication protocols. In an embodiment, vehicle A 780 and/or vehicle B 790 may support various and multiple modes of wireless communication such as, for example, using V2X, Global System for Mobile Communications (GSM), Wideband Code Division Multiple Access (WCDMA), Code-division multiple access (CDMA), High Rate Packet Data (HRPD), Wi-Fi, Bluetooth, WiMAX, LTE, 5G new radio access technology (NR) communication protocols, etc.

In an embodiment, vehicle A may communicate over WAN networks using WAN protocols via base station 720 or with WLAN access point 730 using WLAN protocols such as Wi-Fi. A vehicle may also support wireless communication using a WLAN or PAN (such as Bluetooth or ZigBee), for example.

Vehicle A 780 and/or vehicle B 790, in an embodiment, may contain one or more GNSS receivers such as GNSS receiver 480 for reception of GNSS signals 712, from GNSS satellites 710, for location determination, time acquisition and time maintenance. Various GNSS systems may be supported alone or in combination, using GNSS receiver 480 or other receiver, to receive signals from Beidou, Galileo, GLObal NAvigation Satellite System (GLONASS), and/or Global Positioning System (GPS), and various regional navigational systems such as Quasi-Zenith Satellite System (QZSS) and NavIC or Indian Regional Navigation Satellite System (IRNSS). Other wireless systems may be utilized such as those depending on beacons such as, in an example, one or more RSU(s) 725, one or more WLAN access points 730 or one or more base stations 720. Various GNSS signals 712 may be utilized in conjunction with car sensors to determine location, velocity, proximity to other vehicles such as between vehicle A 780 and vehicle B 790.

In an embodiment, vehicle A and/or vehicle B may access GNSS measurements and/or locations determined at least in part using GNSS as provided by mobile device 700, which, in an embodiment would also have GNSS, WAN, Wi-Fi and other communications receivers and/or transceivers. In an embodiment, vehicle A 780 and/or vehicle B 790 may access GNSS measurements (such as pseudorange measurements, Doppler measurements and satellite IDs) and/or locations determined at least in part using GNSS as provided by mobile device 700 as a fallback in case GNSS receiver 480 fails or provides less than a threshold level of location accuracy.

Vehicle A 780 and/or Vehicle B 790 may access various servers on the network such as vehicle information server 755, route server 745, location server 760, map server 750, and environmental data server 740.

Vehicle information server 755, may provide information describing various vehicles such as antenna location, vehicle size and vehicle capabilities, as may be utilized in making decisions in regards to maneuvers relative to nearby cars such as whether they are capable of stopping or accelerating in time, whether they are autonomously driven, autonomous driving capable, communications capable. In an embodiment, vehicle information server 755 may also provide information in regard to vehicle size, shape, capabilities, identification, ownership, occupancy, and/or determined location point (such as, for example, the location of the GNSS receiver) and the location of the car boundaries relative to the determined location point.

Route server 745, may receive current location and destination information, and provide routing information for the vehicle, map data, alternative route data and/or traffic and street conditions data.

Location server 760, in an embodiment, may provide location determination capabilities, transmitter signal acquisition assistance (such as GNSS satellite orbital predictions information, time information approximate location information and/or approximate time information), transceiver almanacs such as those containing identification of and location for Wi-Fi access points and base stations, and, in some embodiments, additional information relative to the route such as speed limits, traffic, and road status/construction status. Map server 750 which may provide map data, such as road locations, points of interest along the road, address locations along the roads, road size, road speed limits, traffic conditions, and/or road conditions (wet, slippery, snowy/icy, etc.), road status (open, under construction, accidents, etc.). Environmental data server 740 may, in an embodiment, provide weather and/or road related information, traffic information, terrain information, and/or road quality & speed information and/or other pertinent environmental data.

In an embodiment, Vehicles 780 and 790 and mobile devices 700, in FIG. 7, may communicate over network 770 via various network access points such as WLAN access point 730 or wireless WAN base station 720 over network 770. Vehicles 780 and 790 and mobile devices 700 may also, in some embodiments, communicate directly between devices, between vehicles and device to vehicle and vehicle to device using various short range communications mechanisms to communicate directly without going over network 770, such as via Bluetooth, Zigbee and 5G new radio standards.

FIG. 8 comprises a functional block diagram of a vehicle 800, according to an embodiment. As noted, a vehicle 800 may comprise a V2X device 400. Accordingly, example hardware and/or software components for executing the blocks shown in FIG. 8 are illustrated in FIG. 4.

As shown in FIG. 8, vehicle 800 may receive vehicle and environment information from vehicle external sensors 802, vehicle internal sensors 804, vehicle capabilities 806, external wireless information such as the location of other vehicles and GNSS measurement information 808 (from the environment, from other vehicles, from RSU(s), from system servers) and/or from vehicle motion state 810 (describing current and/or future motion states). The received vehicle, sensor, and environment information may, in an embodiment, be processed in one or more processing unit(s) 410, DSP(s) 420, and memory 460 (shown in FIG. 4), connected and configured to provide external object sensing and classification, prediction and planning, and maneuver execution, as well as to determine and update V2X or other wireless data element values, including GNSS data element values, and to transmit, via a wireless communication interface 430, messaging including the determined data elements. The messaging and data elements may be sent and received via various means, protocols and standards, such as via Society of Automotive Engineers (SAE) or European Telecommunications Standards Institute (ETSI) CV2X messages and/or other wireless V2X protocols supported by wireless communication interface 430.

Inter-vehicle relative location determination block 828 may be used to determine relative location of vehicles in an area of interest. In an embodiment, GNSS data is exchanged with vehicles, or other devices such as RSUs, to determine and/or verify and/or increase the accuracy of a relative location associated with other vehicles or devices. In one embodiment, determining vehicles (or other devices) within an area of interest may utilize broadcast location information such as broadcast latitude and longitude received in messages from other vehicles other devices and location information for vehicle 800 to determine an approximate relative location and/or an approximate range between vehicles.

In an embodiment, other vehicle-related input sources, such as servers 755, 745, 760, 750, and 740, may provide information such as vehicle information, routing, location assistance, map data and environmental data and provide input on and/or complement and/or be used in conjunction with the other inputs, for example road location data, map data, driving condition data and other vehicle-related data inputs, used in conjunction with inter-vehicle maneuver coordination 824 to determine maneuver execution 826. In an embodiment, the map data may include locations of roadside units relative to the road location, where the vehicle may utilize relative positioning between an RSU in combination with the map data to determine positioning relative to the road surface, particularly in situations where other systems may fail such as due to low visibility weather conditions (snow, rain, sandstorm, etc.). In an embodiment, map data from map server 750 may be utilized in conjunction with relative and/or absolute data from neighboring vehicles and/or from RSU(s) 725 to determine high confidence absolute location for a plurality of vehicles and relative location with respect to the road/map. For example, if vehicle A 780 has more high accuracy/high confidence location than other vehicles in communication with vehicle A 780, such as vehicle B 790 may use GNSS information for a highly accurate relative location and the highly accurate location from vehicle A 780 sent to vehicle B 790 to determine a highly accurate location for vehicle B 790, even if the systems of vehicle B 790 are otherwise unable to calculate a highly accurate location in a particular situation or environment. In this situation, the presence of vehicle A with a highly accurate location determination system provides benefits to all surrounding vehicles by sharing one or more highly accurate locations along with ongoing relative location information. Furthermore, assuming the map data from map server 750 is accurate, the ability to propagate highly accurate location data from vehicle A 780 to surrounding vehicles such as vehicle B 790 enables the surrounding vehicles to also accurately determine their relative location versus the map data, even in otherwise troublesome signal/location environments. Vehicle information server 755 may provide vehicle information such as size, shape, and antenna location which may be utilized, for example, by vehicle A or other vehicles to determine not just the relative location between the GNSS receiver on vehicle A 780 and, for example, vehicle B 790, but also the distance between the closest points of Vehicle A 780 and Vehicle B 790. In an embodiment, traffic information from the traffic control and optimization server 765 may be utilized to determine overall path selection and rerouting, used in conjunction with route server 745 (in an embodiment). In an embodiment, environmental data server 740 may provide input on road conditions, black ice, snow, water on the road and other environmental conditions which may also impact the decisions and decision criteria in inter-vehicle maneuver coordination block 824 and maneuver execution block 826. For example, in icy or rainy conditions, the vehicle 800 may execute and/or request increased inter-vehicle distance from adjacent vehicles or may choose route options that avoid road hazard conditions such as black ice and standing water.

Block 828 may be implemented using various dedicated or generalized hardware and software, such as using processing unit(s) 410 and/or DSP 420 and memory 460 (again, as shown in FIG. 4) or, in an embodiment, in specialized hardware blocks such as dedicated sensor processing and/or vehicle messaging cores. According to some embodiments, the location of nearby vehicles may be determined through various means such as based on signal-based timing measurements such Round-Trip-Time, Time Of Arrival (TOA), signal strength of a broadcast signal for vehicles, and/or a distance determined based upon broadcast latitude and longitude from a neighboring vehicle and the current location of the vehicle. Additionally or alternatively, location of nearby vehicles may be determined from sensor measurements such as LIght Detection And Ranging (LIDAR), RAdio Detection And Ranging (RADAR), SOund Navigation And Ranging (SONAR), and camera measurements. In an embodiment, some or all of blocks 802, 804, 806, 808 and/or 810 may have dedicated processing cores, for example, to improve performance and reduce measurement latency. In an embodiment, some or all of blocks 802, 804, 806, 808 and/or 810 may share processing with block 828.

Vehicle external sensors 802 may comprise, in some embodiments, cameras, LIDAR, RADAR, SONAR, proximity sensors, rain sensors, weather sensors, GNSS receivers 480 and received data used with the sensors such as map data, environmental data, location, route and/or other vehicle information such as may be received from other vehicles, devices and servers such as, in an embodiment, map server 750, route server 745, vehicle information server 755, environmental data server 740, location server 760, and/or from associated devices such as mobile device 700, which may be present in or near to the vehicle such as vehicle A 780. For example, in an embodiment, mobile device 700 may provide an additional source of GNSS measurements, may provide an additional source of motion sensor measurements, or may provide network access as a communication portal to a WAN, Wi-Fi or other network, and as a gateway to various information servers such as servers 740, 745, 750, 755, 760, and/or 765.

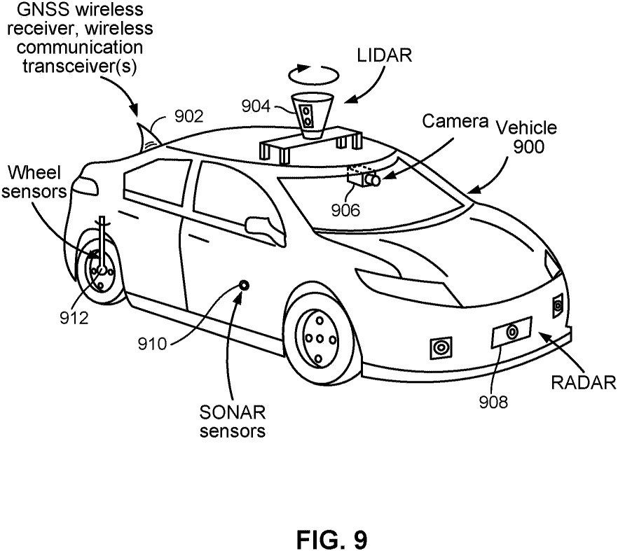

It is understood that the vehicle 800 may contain one or a plurality of cameras. In an embodiment, a camera may be front facing, side facing, rear facing or adjustable in view (such as a rotatable camera). As shown in FIG. 9, for example, there may be multiple cameras 906 facing the same plane. For example, the cameras 906 and bumper-mounted camera at 908 may comprise two front facing cameras, one focused on lower objects and/or a lower point of view (such as bumper mounted) for parking purposes and one focusing on a higher point of view such as to track traffic, other vehicles, pedestrians and more distant objects. In an embodiment, various views may be stitched and/or may be correlated against other inputs such as V2X input from other vehicles to optimize tracking of other vehicles and external entities and objects and/or to calibrate sensor systems against each other. LIDAR 904 may be roof mounted and rotating or may be focused on a particular point of view (such as front facing, rear facing, side facing). LIDAR 904 may be solid state or mechanical. Proximity sensors may be ultrasonic, RADAR -based, light-based (such as based on infrared range finding), and/or capacitive (surface touch oriented or capacitive detection of metallic bodies). Rain and Weather sensors may include various sensing capabilities and technologies such as barometric pressure sensors, moisture detectors, rain sensors, and/or light sensors and/or may leverage other pre-existing sensor systems. GNSS receivers may be roof-mounted, such as in the fin antenna assembly at the rear of the roof of a car, hood or dash mounted or otherwise placed within the exterior or interior of the vehicle.

In an embodiment, vehicle internal sensors 804 may comprise wheel sensors 912 such as tire pressure sensors, brake pad sensors, brake status sensors, speedometers and other speed sensors, heading sensors and/or orientation sensors such as magnetometers and geomagnetic compasses, distance sensors such as odometers and wheel tic sensors, inertial sensors such as accelerometers and gyros as well as inertial positioning results using the above-mentioned sensors, and yaw, pitch and/or roll sensors as may be determined individually or as determined using other sensor systems such as accelerometers, gyros and/or tilt sensors.

Both vehicle internal sensors 804 and vehicle external sensors 802 may have shared or dedicated processing capability. For example, a sensor system or subsystem may have a sensor processing core or cores that determines, based on measurements and other inputs from accelerometers, gyros, magnetometers and/or other sensing systems, car status values such as yaw, pitch, roll, heading, speed, acceleration capability and/or distance, and/or stopping distance. The different sensing systems may communicate with each other to determine measurement values or send values to block 828 to determine vehicle location. The car status values derived from measurements from internal and external sensors may be further combined with car status values and/or measurements from other sensor systems using a general or applications processor. For example, blocks 828 and/or 824 or may be implemented on a dedicated or a centralized processor to determine data element values for V2X messaging which may be sent utilizing wireless communication interface 430 or via other communication transceivers. In an embodiment, the sensors may be segregated into related systems, for example, LIDAR, RADAR, motion, wheel systems, etc., operated by dedicated core processing for raw results to output car status values from each core that are combined and interpreted to derive combined car status values, including capability data elements and status data elements, that may be used to control or otherwise affect car operation and/or as messaging steps shared with other vehicles and/or systems via V2X or other messaging capabilities. These messaging capabilities may be based on, in an embodiment, a variety of wireless-related, light-related or other communication standards, such as those supported by wireless communication interface 430 and antenna(s) 432.

In an embodiment, vehicle capabilities 806 may comprise performance estimates for stopping, breaking, acceleration, and turning radius, and autonomous and/or non-autonomous status and/or capability or capabilities. The capability estimates may be based upon stored estimates, which may be loaded, in an embodiment, into memory. These estimates may be based on empirical performance numbers, either for a specific vehicle, or for averages across one or more vehicles, and/or one or more models for a given performance figure. Where performance estimates for multiple models are averaged or otherwise combined, they may be chosen based on similar or common features. For example, vehicles with similar or the same weight and the same or similar drive trains may share performance estimates for drive-performance related estimates such as breaking/stopping distance, turning radius, and acceleration performance. Vehicle performance estimates may also be obtained, for example, using external V2X input(s) 808, over a wireless network from vehicular data servers on the network. This is particularly helpful to obtain information for vehicles that are not wireless capable and cannot provide vehicular information directly. In an embodiment, vehicle capabilities 806 may also be influenced by car component status such as tire wear, tire brand capabilities, brake pad wear, brake brand and capabilities, and engine status. In an embodiment, vehicle capabilities 806 may also be influenced by overall car status such as speed, heading and by external factors such as road surface, road conditions (wet, dry, slipperiness/traction), weather (windy, rainy, snowing, black ice, slick roads, etc.). In many cases, wear, or other system degradation, and external factors such as weather, road surface, road conditions, etc. may be utilized to reduce, validate or improve performance estimates. In some embodiments, actual measured vehicle performance such as measuring vehicular stopping distance and/or acceleration time per distance, may be measured and/or estimated based on actual vehicular driving-related performance. In an embodiment, more recently measured performance may be weighted more heavily or given preference over older measurements, if measurements are inconsistent. Similarly, in an embodiment, measurements taken during similar conditions such as in the same type of weather or on the same type of road surface as is currently detected by the vehicle, such as via vehicle external sensors 802 and/or vehicle internal sensors 804, may be weighted more heavily and/or given preference in determining capability.

V2X vehicle sensing, prediction, planning execution 812 handles the receipt and processing of information from blocks 802, 804, 806, 808 and 810, via external object sensing and classification block 814, in part utilizing sensor fusion and object classification block 816 to correlate, corroborate and/or combine data from input blocks 802, 804, 806, 808 and 810. Block 814 external object sensing and classification determines objects present, determines type of objects (car, truck, bicycle, motorcycle, pedestrian, animal, etc.) and/or object status relative to the vehicle, such as movement status, proximity, heading, and/or position relative to the vehicle, size, threat level, and vulnerability priority (a pedestrian would have a higher vulnerability priority versus road litter, for example). In an embodiment, block 814 may utilize GNSS measurements messages from other vehicles to determine the relative positioning to other vehicles. This output from block 814 may be provided to prediction and planning block 818, which determines detected objects and vehicles and their associated trajectory via block 820 and determines vehicle maneuver and path planning in block 822, the outputs of which are utilized in block 826 vehicle maneuver execution either directly or via V2X inter-vehicle negotiation block 824, which would integrate and account for maneuver planning, location and status received from other vehicles. V2X inter-vehicle negotiation accounts for the status of neighboring vehicles and enables negotiation and coordination between neighboring or otherwise impacted vehicles based on vehicle priority, vehicle capabilities (such as the ability to stop, decelerate or accelerate to avoid collision), and, in some embodiments, various conditions such as weather conditions (rainy, foggy, snow, wind), road conditions (dry, wet, icy, slippery). These include, for example, negotiation for timing and order to pass through an intersection between cars approaching the intersection, negotiation for lane change between adjacent cars, negotiation for parking spaces, negotiation for access to directional travel on a single lane road or to pass another vehicle. Inter-vehicle negotiation may also include time-based and/or distance-based factors such as appointment time, destination distance and estimated route time to reach destination, and, in some embodiments, type of appointment and importance of the appointment.

FIG. 9 is a perspective view of an example vehicle 900, according to an embodiment, capable of communicating with other vehicles and/or V2X entities in the previously-described embodiments. Here, some of the components discussed with regard to FIG. 4 and earlier embodiments are shown. As illustrated and previously discussed, a vehicle 900 can have camera(s) such as rear view mirror-mounted camera 906, front fender-mounted camera (not shown), side mirror-mounted camera (not shown) and a rear camera (not shown, but typically on the trunk, hatch or rear bumper). Vehicle 900 may also have LIDAR 904, for detecting objects and measuring distances to those objects; LIDAR 904 is often roof-mounted, however, if there are multiple LIDAR units 904, they may be oriented around the front, rear and sides of the vehicle. Vehicle 900 may have other various location-related systems such as a GNSS receiver 480 (typically located in the shark fin unit on the rear of the roof, as indicated), various wireless communication interface (such as WAN, WLAN, V2X; typically, but not necessarily, located in the shark fin) 902, RADAR 908 (typically in the front bumper), and SONAR 910 (typically located on both sides of the vehicle, if present). Various wheel sensors 912 and drive train sensors may also be present, such as tire pressure sensors, accelerometers, gyros, and wheel rotation detection and/or counters. In an embodiment, distance measurements and relative locations determined via various sensors such as LIDAR, RADAR, camera, GNSS, and SONAR, may be combined with automotive size and shape information and information regarding the location of the sensor to determine distances and relative locations between the surfaces of different vehicles, such that a distance or vector from a sensor to another vehicle or between two different sensors (such as two GNSS receivers) is incrementally increased to account for the position of the sensor on each vehicle. Thus, an exact GNSS distance and vector between two GNSS receivers would need to be modified based upon the relative location of the various car surfaces to the GNSS receiver. For example, in determining the distance between a rear car’s front bumper and a leading car’s rear bumper, the distance would need to be adjusted based on the distance between the GNSS receiver and the front bumper on the following car, and the distance between the GNSS receiver of the front car and the rear bumper of the front car. E.g., the distance between the front car’s rear bumper and the following car’s front bumper is the relative distance between the two GNSS receivers minus the GNSS receiver to front bumper distance of the rear car and minus the GNSS receiver to rear bumper distance of the front car. It is realized that this list is not intended to be limiting and that FIG. 9 is intended to provide exemplary locations of various sensors in an embodiment of a vehicle comprising a V2X device 400.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, any other physical medium with patterns of holes, RAM, a programmable ROM (PROM), erasable programmable ROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special-purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special-purpose computer or similar special-purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

1. A method of vehicle maneuver coordination, the method comprising:
determining, at a first vehicle, a maneuver for the first vehicle to perform;
determining a priority level corresponding to the maneuver; and
wirelessly transmitting, from the first vehicle, a request to perform the maneuver, wherein the request comprises information indicative of:
the maneuver,
the priority level, and
a window of time in which to perform the maneuver.

2. The method of claim 1, wherein the request is wirelessly transmitted in accordance with vehicle-to-everything (V2X) communication standard.

3. The method of claim 1, wherein the priority level is based on a reason for the maneuver, a vehicle type of the first vehicle, or both.

4. The method of claim 1, further comprising:
receiving, at the first vehicle, an acceptance message from a second vehicle or a Road Side Unit (RSU); and
responsive to receiving the acceptance message, performing the maneuver with the first vehicle.

5. A method of vehicle maneuver coordination, the method comprising:
wirelessly receiving a first request to perform a maneuver from a first vehicle, wherein the first request comprises information indicative of the maneuver, a priority level, and a window of time in which to perform the maneuver;
determining whether to grant the first request based at least in part on the priority level of the first request; and
wirelessly sending a response indicative of whether the first request is granted.

6. The method of claim 5, wherein receiving the first request, determining whether to grant the first request, and wirelessly sending the response, are performed by a second vehicle.

7. The method of claim 6, wherein the second vehicle determines whether to grant the first request additionally based on a priority level of a second request received by the second vehicle from a third vehicle.

8. The method of claim 7, wherein:
determining whether to grant the first request comprises determining to deny the first request based on a determination that the priority level of the second request is higher than the priority level of the first request; and
the response comprises information indicative of a denial of the first request.

9. The method of claim 7, wherein:
determining whether to grant the first request comprises determining to accept the first request based on a determination that the priority level of the second request is lower than the priority level of the first request; and
the response comprises information indicative of an acceptance of the first request.

10. (canceled)

11. (canceled)

12. (canceled)

13. A device for vehicle maneuver coordination of a first vehicle, the device comprising:
a communication interface;
a memory; and
one or more processing units communicatively coupled with the communication interface and memory and configured to cause the device to:
determine a maneuver for the first vehicle to perform; and
determine a priority level corresponding to the maneuver;
wherein the communication interface is configured to wirelessly transmit a request to perform the maneuver, wherein the request comprises information indicative of:
the maneuver,
the priority level, and
a window of time in which to perform the maneuver.

14. The device of claim 13, wherein the communication interface is configured to wireless transmit the request in accordance with vehicle-to-everything (V2X) communication standard.

15. The device of claim 13, wherein the priority level is based on a reason for the maneuver, a vehicle type of the first vehicle, or both.

16. The device of claim 13, wherein:
the communication interface is configured to receive an acceptance message from a second vehicle or a Road Side Unit (RSU); and
the one or more processing units are configured to cause the device to, responsive to receiving the acceptance message, perform the maneuver with the first vehicle.

17. A device for vehicle maneuver coordination, the device comprising:
a communication interface configured to wirelessly receive a first request to perform a maneuver from a first vehicle, wherein the first request comprises information indicative of the maneuver, a priority level, and a window of time in which to perform the maneuver;
a memory; and
one or more processing units communicatively coupled with the communication interface and memory and configured to cause the device to determine whether to grant the first request based at least in part on the priority level of the first request;
wherein the communication interface is configured to wirelessly send a response indicative of whether the first request is granted.

18. The device of claim 17, wherein the device is a second vehicle.

19. The device of claim 18, wherein the one or more processing units are configured to cause the device to determine whether to grant the first request additionally based on a priority level of a second request received by the second vehicle from a third vehicle.

20. The device of claim 19, wherein:
to determine whether to grant the first request, the one or more processing units are configured to determine to deny the first request based on a determination that the priority level of the second request is higher than the priority level of the first request; and
the response comprises information indicative of a denial of the first request.

21. The device of claim 19, wherein:
to determine whether to grant the first request, the one or more processing units are configured to determine to accept the first request based on a determination that the priority level of the second request is lower than the priority level of the first request; and
the response comprises information indicative of an acceptance of the first request.

22. A non-transitory computer-readable medium of a first vehicle, the non-transitory computer-readable medium having instructions embedded therewith, which, when executed by one or more processing units, cause the one or more processing units to:
determine a maneuver for the first vehicle to perform;
determine a priority level corresponding to the maneuver; and
output, for wireless transmission from the first vehicle, a request to perform the maneuver, wherein the request comprises information indicative of:
the maneuver,
the priority level, and
a window of time in which to perform the maneuver.

23. The non-transitory computer-readable medium of claim 22, wherein the request is wirelessly transmitted in accordance with vehicle-to-everything (V2X) communication standard.

24. The non-transitory computer-readable medium of claim 22, wherein the priority level is based on a reason for the maneuver, a vehicle type of the first vehicle, or both.

25. The non-transitory computer-readable medium of claim 22, wherein the instructions, which, when executed by the one or more processing units, cause the one or more processing units to:
receive, at the first vehicle, an acceptance message from a second vehicle or a Road Side Unit (RSU); and
responsive to receiving the acceptance message, perform the maneuver with the first vehicle.

26. A non-transitory computer-readable medium, the non-transitory computer-readable medium having instructions embedded therewith, which, when executed by one or more processing units, cause the one or more processing units to:
receive a first request to perform a maneuver from a first vehicle, wherein the first request comprises information indicative of the maneuver, a priority level, and a window of time in which to perform the maneuver;
determine whether to grant the first request based at least in part on the priority level of the first request; and
output, for wirelessly transmission, a response indicative of whether the first request is granted.

27. The non-transitory computer-readable medium of claim 26, wherein the non-transitory computer-readable medium is part of a second vehicle.

28. The non-transitory computer-readable medium of claim 27, wherein the instructions, which, when executed by the one or more processing units, cause the one or more processing units to determine whether to grant the first request additionally based on a priority level of a second request received by the second vehicle from a third vehicle.

29. The non-transitory computer-readable medium of claim 28, wherein:
to determine whether to grant the first request, the instructions, which, when executed by the one or more processing units, cause the one or more processing units to determine to deny the first request based on a determination that the priority level of the second request is higher than the priority level of the first request; and
the response comprises information indicative of a denial of the first request.

30. The non-transitory computer-readable medium of claim 28, wherein:
to determine whether to grant the first request, the instructions, which, when executed by the one or more processing units, cause the one or more processing units to determine to accept the first request based on a determination that the priority level of the second request is lower than the priority level of the first request; and
the response comprises information indicative of an acceptance of the first request.
